(19) United States
(12) Patent Application Publication
(10) Pub. No.: US 2026/0175695 A1
(43) Pub. Date: Jun. 25, 2026

(54) DRIVE CONTROL SYSTEM AND METHOD FOR FUEL CELL VEHICLE

(71) Applicants: Hyundai Motor Company, Seoul (KR); Kia Corporation, Seoul (KR)

(72) Inventor: Dong Woo KANG, Hwaseong-Si (KR)

(21) Appl. No.: 19/351,635

(22) Filed: Oct. 7, 2025

(30) Foreign Application Priority Data
Dec. 24, 2024 (KR) 10-2024-0195375

(51) Int. Cl. B60L 3/00; B60L 58/30; H01M 8/04302; H01M 8/0444; H01M 8/04537; H01M 8/04746; H01M 8/04858

(52) U.S. Cl. CPC B60L 3/0053; B60L 58/30; H01M 8/04302; H01M 8/0447; H01M 8/04559; H01M 8/04753; H01M 8/0488; H01M 8/0491; H01M 2250/20

(57) ABSTRACT

Provided is a drive control system for a fuel cell vehicle. A drive control system may include: a gas detector configured to measure, after a startup of a vehicle equipped with a fuel cell stack, a concentration of carbon dioxide contained in an exhaust gas emitted from the fuel cell stack; and a controller circuit. The controller circuit may be configured to: diagnose, based on the measured concentration of the carbon dioxide, a corrosion condition of an electrode of the fuel cell stack; selectively perform, based on the diagnosed corrosion condition, voltage conditioning on the fuel cell stack to maintain an output voltage of the fuel cell stack at a predetermined first voltage; and control, based on the output voltage of the fuel cell stack, an operation of the fuel cell stack.

### CROSS REFERENCE TO RELATED APPLICATION

The present application claims priority to Korean Patent Application No. 10-2024-0195375, filed Dec. 24, 2024, the entire contents of which are incorporated herein by reference for all purposes.

### TECHNICAL FIELD

The present disclosure relates to a fuel cell vehicle and, more particularly, to a drive control system and method for a fuel cell vehicle.

### BACKGROUND

Fuel cell vehicles may be equipped with a fuel cell stack as a power source thereof. The fuel cell stack is a collection of a plurality of electrically connected fuel cells, which generate electricity from supplied fuel and air.

The fuel electrodes (e.g., anodes) of the fuel cell stack may be supplied with fuel, and the air electrodes (e.g., cathodes) of the fuel cell stack may be supplied with air. Hydrogen ions may be generated by a catalytic reaction at the anodes and transferred to the cathodes through an electrolyte membrane. At the cathodes, electrical energy may be generated through the electrochemical reaction of hydrogen ions and oxygen.

The byproducts of electrical energy generation process of the fuel cell stack, such as water vapor, as well as residual hydrogen and residual air may be discharged from the fuel cell stack through an exhaust duct.

Each of the electrodes (e.g., fuel cell electrodes) of the fuel cell stack, such as the anodes and the cathodes, may include a catalyst carried on a catalyst support. The catalyst may be physically and chemically affixed to and supported on the catalyst support. The catalyst support of the cathode may typically be made of a carbon material, and the catalyst may be typically made of platinum (Pt).

When fuel cell vehicles start and are driven after being left unattended for an extended period of time or after idling (or idle stopping), excessive corrosion may occur on the fuel cell electrodes of the vehicle. Excessive corrosion of the fuel cell electrodes may result in performance degradation of the fuel cell stack.

The matters described in this Background section are only for enhancement of understanding of the background of the disclosure, and should not be taken as acknowledgement that they correspond to prior art already known to those skilled in the art.

### SUMMARY

The present disclosure has been made to address problems occurring in at least some implementations, and the present disclosure is intended to provide a drive control system and method for a fuel cell vehicle which prevents performance degradation of a fuel cell stack by selectively performing controls to reduce corrosion of the fuel cell electrodes based on the concentration of carbon dioxide in the exhaust gas of the fuel cell stack.

The objective of the present disclosure is not limited to the aforementioned description, and other objectives not explicitly disclosed herein will be clearly understood by those skilled in the art from the description provided hereinafter.

According to one or more example embodiments of the present disclosure, a drive control system may include: a gas detector configured to measure, after a startup of a vehicle equipped with a fuel cell stack, a concentration of carbon dioxide contained in an exhaust gas emitted from the fuel cell stack; and a controller circuit configured to: diagnose, based on the measured concentration of the carbon dioxide, a corrosion condition of an electrode of the fuel cell stack; determine, based on the diagnosed corrosion condition, whether to perform voltage conditioning on the fuel cell stack to maintain an output voltage of the fuel cell stack at a predetermined first voltage (e.g., a predetermined voltage or a voltage range); and control, based on the output voltage of the fuel cell stack, an operation of the fuel cell stack.

The controller circuit may be further configured to: determine an amount of increase in the measured concentration of the carbon dioxide after the startup of the vehicle; and determine, based on the amount of increase in the measured concentration of the carbon dioxide, whether to perform the voltage conditioning.

The controller circuit may be configured to determine the amount of increase in the measured concentration of the carbon dioxide by: determining a difference between a first carbon dioxide concentration value, measured at a first time during the startup of the vehicle, and a second carbon dioxide concentration value, measured at a second time during the startup of the vehicle. The second time may be later than the first time. The output voltage of the fuel cell stack may reach a predetermined second voltage at the second time.

The controller circuit may be configured to selectively perform the voltage conditioning by: based on the amount of increase in the measured concentration of the carbon dioxide being less than or equal to a first threshold value, not performing the voltage conditioning.

The controller circuit may be configured to selectively perform the voltage conditioning by: based on an input signal from a driver of the vehicle and based on the amount of increase in the measured concentration of the carbon dioxide being greater than a first threshold value and less than a second threshold value, performing the voltage conditioning. The second threshold value may be greater than the first threshold value.

The controller circuit may be configured to perform the voltage conditioning further based on the amount of increase in the measured concentration of the carbon dioxide being greater than or equal to the second threshold value.

The input signal may be transmitted to the controller circuit via a mobile device associated with the driver.

The controller circuit may be configured to perform the voltage conditioning for a predetermined period of time.

The controller circuit may be further configured to, after performing the voltage conditioning, limit an output current of the fuel cell stack for a predetermined period of time such that the output voltage of the fuel cell stack is maintained at or above the predetermined first voltage.

The controller circuit may be further configured to, while limiting the output current of the fuel cell stack, control an air flow control valve (ACV) to maintain an amount of air supplied to the fuel cell stack at or above a predetermined flow rate.

According to one or more example embodiments of the present disclosure, a method performed by an apparatus of a vehicle may include: after a startup of the vehicle equipped with a fuel cell stack, measuring, by a controller circuit via a gas detector, a concentration of carbon dioxide contained in an exhaust gas emitted from the fuel cell stack; diagnosing, by the controller circuit and based on the measured concentration of the carbon dioxide, a corrosion condition of an electrode of the fuel cell stack; determining, based on the diagnosed corrosion condition, whether to perform voltage conditioning on the fuel cell stack to maintain an output voltage of the fuel cell stack at a predetermined first voltage (e.g., a predetermined voltage or a voltage range); and controlling, based on performing the voltage conditioning of the fuel cell stack, an operation of the fuel cell stack.

The method may further include: determining an amount of increase in the measured concentration of the carbon dioxide after the startup of the vehicle; and determining, based on the amount of increase in the measured concentration of the carbon dioxide, whether to perform the voltage conditioning.

Determining the amount of increase in the measured concentration of the carbon dioxide may include: determining a difference between a first carbon dioxide concentration value, measured at a first time during the startup of the vehicle, and a second carbon dioxide concentration value, measured at a second time during the startup of the vehicle. The second time may be later than the first time. The output voltage of the fuel cell stack may reach a predetermined second voltage at the second time.

The method may further include: determining a second amount of increase in carbon dioxide emission from the fuel cell stack after a second startup of the vehicle; and determining, based on the second amount being less than or equal to a first threshold value, to not perform the voltage conditioning on the fuel cell stack after the second startup of the vehicle.

Performing the voltage conditioning may include: determining, based on an input signal from a driver of the vehicle and based on the amount of increase in the measured concentration of the carbon dioxide being greater than a first threshold value and less than a second threshold value, to perform the voltage conditioning. The second threshold value may be greater than the first threshold value.

The driver input signal may be transmitted to the controller circuit via a mobile device associated with the driver.

Performing the voltage conditioning may include: performing the voltage conditioning further based on the amount of increase in the measured concentration of the carbon dioxide being greater than or equal to a second threshold that is greater than a first threshold.

Performing the voltage conditioning may include performing the voltage conditioning for a predetermined period of time.

The method may further include, after the performing of the voltage conditioning, limiting an output current of the fuel cell stack for a predetermined period of time such that the output voltage of the fuel cell stack is maintained at or above the predetermined first voltage.

The method may further include, while limiting the output current of the fuel cell stack, controlling an air flow control valve (ACV) to maintain an amount of air supplied to the fuel cell stack at or above a predetermined flow rate.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating a drive control system of a fuel cell vehicle;

FIGS. 2 and 3 are flowcharts illustrating a drive control method for a fuel cell vehicle; and

FIG. 4 is a graph showing the voltage conditioning control effect.

FIG. 5 shows an example computing system.

### DETAILED DESCRIPTION

Hereinafter, one or more example embodiments of the present disclosure will be described with reference to the accompanying drawings. Illustrations in the accompanying drawings are provided to assist in the understanding of the example embodiments of the present disclosure and may differ from actually-implemented forms.

It will be understood that, although the terms “first”, “second”, and the like may be used herein to describe various elements, these elements should not be limited by these terms. These terms are only used to distinguish one element from another element. For instance, a first element discussed below could be termed a second element without departing from the teachings of the disclosure. Similarly, the second element could also be termed the first element.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “about” and/or the phrase “maintain . . . at a predetermined voltage” or similar phrases in relation to a reference numerical value, and its grammatical equivalents as used herein, can include the reference numerical value itself and a range of values plus or minus 10% from that reference numerical value. For example, the term “a predetermined voltage 10V” includes 10V and any amount from and including 9V to 11V. As non-limiting examples, the term “at a predetermined voltage” or “at about a predetermined voltage” in relation to a reference numerical value can also include a range of values plus or minus 10%, 9%, 8%, 7%, 6%, 5%, 4%, 3%, 2%, or 1% from that reference numerical value, as the voltage maintained at a predetermined voltage may fluctuate from time to time. Also, it should be understood that a voltage is still maintained at a target voltage of 10V, for example, even if a voltage value temporarily surges to a higher value and returns to about 10V. In some examples, “at” in connection with a number or range measured by a particular method indicates that the given numerical value includes values determined by the variability of that method.

As known in the art, when a fuel cell vehicle equipped with a fuel cell stack starts and is driven after being left unattended for an extended period of time or after idle stopping, excessive electrode corrosion of the fuel cell stack of the vehicle may occur.

The corrosion of the fuel cell electrodes (hereinafter referred to as “electrodes”) may be closely associated with carbon oxide (COH) that is generated on the electrode surface when the voltage of the fuel cell stack is maintained at a low voltage (e.g., a voltage below a threshold level such as below 0.6V). In addition, the longer the fuel cell stack is maintained at such a low voltage, the more COH may be produced, and the more electrode corrosion may occur when the vehicle is subsequently started and driven.

If the voltage of the fuel cell stack is maintained at low voltage (e.g., below a threshold voltage), the COH generated on the electrode surface may comingle with the platinum oxide (PtOH) generated upon the increase of 0.6 V or more in voltage of the fuel cell stack, and carbon dioxide (CO₂) may be generated within the operating voltage range of the fuel cell stack through the reaction of COH and PtOH.

In other words, as the shutdown duration and idle stop time of the fuel cell vehicle increases, the amount of COH generated on the surface of the carbon particles constituting the electrodes increases. The COH generated on the surface of the carbon particles may change to carbon dioxide while the voltage of the fuel cell stack increases, causing deterioration of the electrodes.

The amount of COH generated may increase as the fuel cell stack remains at low voltage for a longer period of time. A large amount of carbon dioxide may be generated in proportion to the amount of COH generated during vehicle startup and drive after shutdown and idle stopping of the vehicle.

Table 1 shows an amount of increase and an increase rate of CO₂ as a function of the duration of the voltage of the fuel cell stack being maintained at low voltage (e.g., low limit voltage). In Table 1, the increase (e.g., the amount of increase and the increase rate of carbon dioxide are shown for an example fuel cell stack with a low voltage (e.g., a voltage below a threshold level) of 5 minutes versus 20 minutes. In Table 1, it can be seen that the amount of carbon dioxide generated increases as the fuel cell stack is maintained at low voltage for a longer period of time.

TABLE 1

| | | | | Maintained for 20 min. vs. | |
|---|---|---|---|---|---|
| | | | | Maintained for 5 min. | |
| Lower | Lower Limit of | | | | CO₂ |
| STACK | Stack Voltage Duration | | | CO₂ | increase |
| VOLTAGE | 5 min. | 10 min. | 20 min. | increase | rate |
| 0.1 V | 4.28 | 5.69 | 8.49 | 4.21 | 98% |
| 0.2 V | 6.41 | 8.66 | 13.44 | 7.03 | 110% |
| 0.3 V | 5.39 | 8.37 | 15.25 | 9.88 | 183% |
| 0.4 V | 4.9 | 8.31 | 15.93 | 11.03 | 225% |

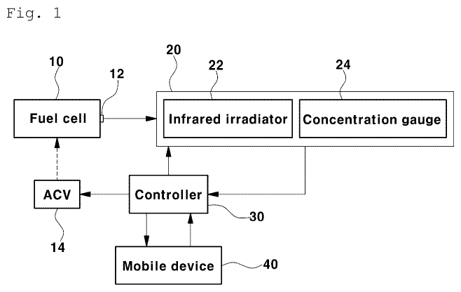

Accordingly, the drive control system of the present disclosure may predict and estimate the amount of electrode corrosion in the fuel cell stack 10 and diagnose the electrode corrosion condition based on measurements from an electrode corrosion predictor 20 illustrated in FIG. 1.

The electrode corrosion predictor 20 may be configured to measure the concentration (or the amount) of carbon dioxide (CO₂) contained in the exhaust gases emitted from the fuel cell stack 10 upon startup of the fuel cell vehicle, and transmit a signal indicative of the measured CO₂ concentration to a controller (also referred to as a controller circuit) 30. The controller 30 may be configured to predict and estimate the amount of electrode corrosion and the electrode surface condition based on the carbon dioxide concentration in the exhaust gases. Accordingly, the electrode corrosion predictor 20 may also be referred to as a carbon dioxide concentration meter, a carbon dioxide analyzer, a carbon dioxide detector, a gas concentration meter, a gas analyzer, a gas detector, etc.

The fuel cell vehicle may be a vehicle powered by the fuel cell stack 10. The exhaust gases may include remaining (e.g., excess) air and by-products after being processed in the cathode(s) (e.g., air electrode(s)) of the fuel cell stack 10. Further, the exhaust gases may include carbon dioxide generated through the reaction of carbon oxide (COH) and platinum oxide (PtOH) on the electrode surfaces of the fuel cell stack 10. The exhaust gases may be discharged to the outside of the fuel cell stack 10 through a cathode exhaust 12 of the fuel cell stack 10.

The electrode(s) may include a catalyst support of carbon material and a platinum catalyst, and the amount of electrode corrosion may refer to the amount of corrosion of the catalyst support of carbon material. In other words, the amount of electrode corrosion may refer to the amount of carbon corrosion of the electrode.

As illustrated in FIG. 1, the electrode corrosion predictor 20 may include an infrared irradiator 22 and a concentration gauge 24. The electrode corrosion predictor 20 may be connected to the cathode exhaust 12 of the fuel cell stack 10 and be supplied with exhaust gases from the cathode exhaust 12.

The infrared irradiator 22 may be configured to irradiate infrared light into the concentration gauge 24 in a rotational manner, and the concentration gauge 24 measures the concentration of carbon dioxide contained in the exhaust gases passing through the concentration gauge 24 by utilizing the infrared light irradiated from the infrared irradiator 22. The concentration gauge 24 may be capable of detecting the concentration of carbon dioxide in the exhaust gases down to parts per million, and measure the concentration of carbon dioxide by non-dispersive infrared spectroscopy.

The carbon dioxide concentration measured by the concentration gauge 24 may be transmitted to the controller 30. The controller 30 may be one of the controllers provided in the vehicle. After having passed through the concentration gauge 24, the exhaust gases are discharged into the atmosphere.

The controller 30 predicts and determines the amount of carbon oxide (COH) production and the carbon corrosion that have occurred on the electrode surface based on the carbon dioxide concentration included in the signal transmitted from the concentration gauge 24 of the electrode corrosion predictor 20.

In other words, the controller 30 diagnoses the surface condition and corrosion condition of the electrode based on the signal received from the concentration gauge 24. As a result of the diagnosis, if the controller 30 determines that the surface of the electrode is excessively corroded, the controller 30 may perform a predetermined voltage conditioning control to suppress and minimize the occurrence of corrosion on the electrode surface during subsequent driving of the vehicle.

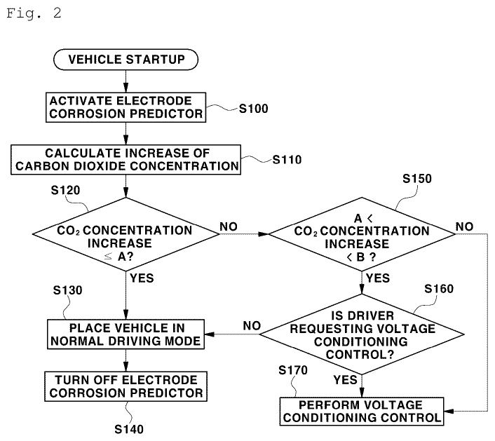

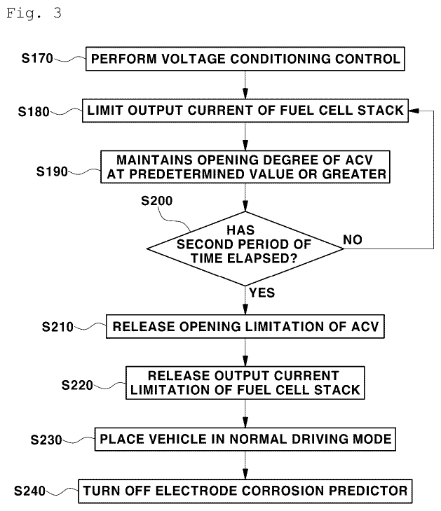

Hereinafter, a method of suppressing and minimizing the occurrence of corrosion on the electrode surface during vehicle driving will be described with reference to FIGS. 2 and 3.

FIG. 2 illustrates a process of determining whether to perform voltage conditioning control upon vehicle startup, and FIG. 3 illustrates a control process of suppressing and minimizing electrode corrosion after performing the voltage conditioning control.

As illustrated in FIG. 2, in S100, the controller 30 activates the electrode corrosion predictor 20 upon vehicle startup, which may be done directly by the driver in the vehicle or remotely using a telematics service.

If the electrode corrosion predictor 20 is supplied with exhaust gases from the cathode exhaust 12 of the fuel cell stack 10, the electrode corrosion predictor 20 may measure the concentration of carbon dioxide in the exhaust gases. In this case, the electrode corrosion predictor 20 may measure the carbon dioxide concentration before and after the output voltage of the fuel cell stack 10 reaches a predetermined first voltage, respectively, after a vehicle startup.

The output voltage of the fuel cell stack 10 may reach the first voltage after the vehicle starts. In other words, the first voltage may be a voltage of the fuel cell stack 10 that is typically reached when (e.g., after) the vehicle starts, and may be set to 1.0 V, for example.

The electrode corrosion predictor 20 may measure the concentration of carbon dioxide in response to reception of a measurement request signal from the controller 30. The controller 30 may request the electrode corrosion predictor 20 to measure the concentration of carbon dioxide before and after the output voltage of the fuel cell stack 10 reaches the first voltage after vehicle startup, respectively.

The controller 30 may receive an output voltage of the fuel cell stack 10 from a voltage sensor (not shown) for measuring the output voltage of the fuel cell stack 10. The controller 30 may send a measurement request signal to the electrode corrosion predictor 20 based on the output voltage of the fuel cell stack 10. The controller 30 may request the electrode corrosion predictor 20 to measure the carbon dioxide concentration even when the output voltage value of the fuel cell stack 10 reaches the first voltage.

In S110, the controller 30 may calculate and determine the difference between a carbon dioxide concentration (e.g., a first carbon dioxide concentration) measured before the output voltage of the stack 10 reaches the first voltage and a carbon dioxide concentration (e.g., a second carbon dioxide concentration) measured after the output voltage of the stack 10 reaches the first voltage as an increase of carbon dioxide concentration. The controller 30 may determine the value of the first carbon dioxide concentration value minus the second carbon dioxide concentration value as the increase in the carbon dioxide concentration of the exhaust gases. The second carbon dioxide concentration may be measured at a time when the output voltage of the stack 10 reaches the first voltage.

The controller 30 compares the carbon dioxide concentration increase with a predetermined first increase A (S120). If the carbon dioxide concentration increase is less than or equal to the first increase A, the controller 30 may not perform voltage conditioning control and places the vehicle in a normal driving mode in S130 and turn off the electrode corrosion predictor 20 in S140. The normal driving mode may be a mode in which the vehicle is driven depending on the driver's demands and maneuvers. For example, if the vehicle enters the normal driving mode, the vehicle speed may be proportional to the amount of accelerator pedal depression.

Furthermore, the controller 30 compares the carbon dioxide concentration increase with a predetermined second increase B if the carbon dioxide concentration increase exceeds the first increase A in S150. The first increase A may be set to a value that is judged not to have excessive corrosion on the electrode surface, and the second increase B may be set to a value that is judged to have excessive corrosion on the electrode surface. For example, the first increase A may be 500 ppm and the second increase B may be 900 ppm.

If, as a result of the comparison in S150, the increase in the carbon dioxide concentration of the exhaust gases is greater than the first increase A and is less than the second increase B, the controller 30 may selectively perform voltage conditioning control (S170). In this case, the controller 30 may perform the voltage conditioning control based on a driver input signal. The driver input signal may include information about whether the driver has requested to perform the voltage conditioning control.

If the driver input signal includes information of a request to perform the voltage conditioning control, the controller 30 may perform the voltage conditioning control. If the driver input signal does not include information about requesting to perform voltage conditioning control, the controller 30 may not perform voltage conditioning control.

The driver input signal may be input to the controller 30 via a user interface (not shown) provided in the vehicle, or may be transmitted to the controller 30 remotely via a portable mobile device 40 capable of telematics. The mobile device 40 may be a device carried and used by the driver.

The controller 30 may determine whether the driver is requesting voltage conditioning control in S160. The controller 30 may determine the driver's request for voltage conditioning control via a driver input signal transmitted from the user interface or the mobile device 40.

If the increase in the carbon dioxide concentration in the exhaust gases is greater than the first increase A and is less than the second increase B, the controller 30 may request a driver input signal from the driver to determine whether to perform the voltage conditioning control. In this case, the controller 30 may request the driver input signal from the driver via a display device (not shown) provided in the vehicle or via the mobile device 40.

Furthermore, if the increase in the carbon dioxide concentration of the exhaust gases is greater than or equal to the second increase B, the controller 30 may perform (e.g., enforce performance of) the voltage conditioning control regardless of the driver input signal in S170. By performing the voltage conditioning control, excessive electrode corrosion during vehicle driving may be suppressed.

The voltage conditioning control may be a control that maintains the output voltage of the fuel cell stack 10 at a predetermined second voltage for a predetermined first period of time. The second voltage may be set to a voltage for generating an oxide film on the platinum (Pt) catalyst particles included in the electrodes. For example, the second voltage may be 0.75 V.

By forming a platinum oxide (PtO) film on the platinum catalyst particles of the electrode, the indiscriminate reaction of carbon oxide (COH) generated on the surface of the carbon particles of the electrode with bare platinum (Pt) may be suppressed, and also the excessive electrode corrosion during the vehicle driving and the power generation of the fuel cell stack 10 may be suppressed by changing the carbon oxide (COH) into a C═O oxide in which the bonding of carbon (C) and oxygen (O) is stable. Bare platinum refers to platinum particles that are not coated with a platinum oxide (PtO) film.

In other words, by maintaining the output voltage of the fuel cell stack 10 at the second voltage, the generation of platinum oxide (PtOH), which is a source of electrode corrosion, is prevented and the carbon oxide (COH) is changed into a stable C═O oxide, which in turn suppresses excessive electrode corrosion.

Furthermore, in order to properly passivate the PtO film on the surface of the platinum catalyst particles, it is necessary to maintain the output voltage of the fuel cell stack 10 at a predetermined constant voltage (e.g., the second voltage) for at least the first period of time.

While the voltage conditioning control is executed, it may not be possible to operate the vehicle according to the driver's maneuvers and demands. Accordingly, the longer the time for maintaining the output voltage of the fuel cell stack 10 at the second voltage, the more inconvenient it may be for the driver to use the vehicle.

Therefore, in order to minimize the inconvenience to the driver, the minimum time for which the platinum oxide (PtO) film may be stably formed on the surface of the catalyst particles is set to the first period of time, and the output voltage of the stack 10 is maintained at the second voltage only for the first period of time. For example, the first period of time may be set to 1 minute.

If the output voltage of the stack 10 is maintained at 0.75 V for 1 minute, a platinum oxide (PtO) film of 0.57 coulomb (C) may be formed on the surface of the catalyst particles of the electrode.

As illustrated in FIG. 3, after performing the voltage conditioning control in S170, the controller 30 may limit the output current of the fuel cell stack 10 to a predetermined first current value or less in S180. This is to limit the output current of the stack 10 below the first current to inhibit further electrode corrosion during vehicle driving.

In other words, after performing the above voltage conditioning control, the output current of the stack 10 may be limited to the first current or less to minimize further electrode corrosion that may occur during vehicle driving.

By limiting the output current of the stack 10 to the first current or less, the output voltage of the stack 10 may be maintained at the second voltage or greater, so that the lower limit of the output voltage of the stack 10 is limited to the second voltage or less. In this case, the output current of the stack 10 may be limited to the first current or less for a predetermined second period of time. The first current may be determined as a current for preventing the output voltage of the stack 10 from falling below the second voltage, that is, a current for maintaining the output voltage of the stack 10 at the second voltage or greater. Further, the second period of time may be determined as 5 minutes.

The controller 30 may prevent the output voltage of the stack 10 from decreasing below the second voltage for the second period of time in an initial driving section where the electrodes are susceptible to corrosion after vehicle startup, thereby inhibiting further production of carbon oxide (COH) on the surface of the carbon particles of the electrodes.

If the output current of the stack 10 is limited to the first current or less, the driver's use of the vehicle may be partially restricted, and the vehicle may enter an idle stop mode. in the idle stop mode, the power generation of the fuel cell stack 10 may be temporarily stopped after vehicle startup. The idle stop mode may be distinct from a complete shutdown of the power generation of the stack 10.

Thus, if the output current of the stack 10 is limited to the first current or less, the controller 30 may maintain the opening degree of the air flow control valve (ACV) 14 at a predetermined value (e.g., angle value) or greater in S190. The ACV 14 may be for controlling the amount of air supplied to the fuel cell stack 10, which is determined in proportion to the amount of opening of the ACV 14. In other words, the controller 30 may control the ACT to maintain the amount of air supplied to the fuel cell stack 10 at or above a predetermined flow rate. In S190, the opening degree of the ACV 14 may be maintained and limited to 5° or greater.

By maintaining the opening degree of the ACV 14 at a predetermined value or greater while limiting the output current of the stack 10 to the first current or less, it may be possible to prevent the output voltage of the stack 10 from falling to the second voltage or less even when the vehicle enters the idle stop mode.

In S200, the controller 30 may determine whether the second period of time has elapsed based on the time when the output current limitation of the stack 10 was initiated. If the controller 30 determines that the second period of time has elapsed since the start of limiting the output current of the stack 10, the controller 30 may release the opening limitation of the ACV 14 in S210 and release the output current limitation of the fuel cell stack 10 in S220.

In other words, after limiting the output current of the stack 10 to the first current or less for the second period of time and limiting the opening degree of ACV 14 to a predetermined value or greater, the controller 30 may release the opening limitation of ACV 14 (S210) and releases the output current limitation of the fuel cell stack 10 (S220).

The controller 30 may place the vehicle in a normal driving mode in S230 and turn off the electrode corrosion predictor 20 in S240.

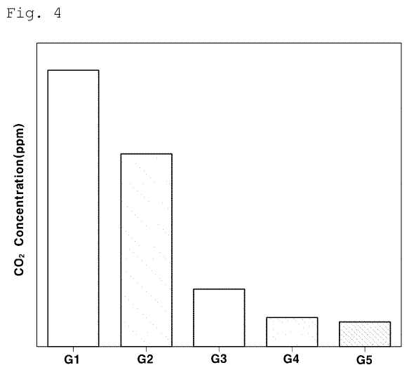

FIG. 4 is a graph illustrating the voltage conditioning control effect.

In FIG. 4, G1, G2, G3, G4, and G5 represent carbon dioxide concentration values measured after limiting the output voltage of the fuel cell stack to a lower value with conditions of 0.1 V, 0.4 V, 0.6 V, 0.7 V, and 0.75 V, respectively. The carbon dioxide concentration values may be measured for the exhaust gases emitted from the fuel cell stack when (e.g., after) the vehicle starts. In this case, after the fuel cell stack was operated in a state in which all other conditions were set to be the same except for the output voltage of the fuel cell stack, the carbon dioxide concentration of the exhaust gases was measured.

Referring to FIG. 4, it can be seen that the carbon dioxide concentration in the exhaust gases was significantly reduced when the output voltage of the fuel cell stack was maintained and limited to 0.75 V (G5) according to the present disclosure, compared to when the output voltage of the fuel cell stack was maintained and limited to a voltage lower than 0.75 V (G1 to G4).

As the measured value of the carbon dioxide concentration in G5 was significantly reduced compared to the carbon dioxide concentration in G1 to G4, it was confirmed that the corrosion of the fuel cell electrodes was significantly reduced by the voltage conditioning control according to the present disclosure.

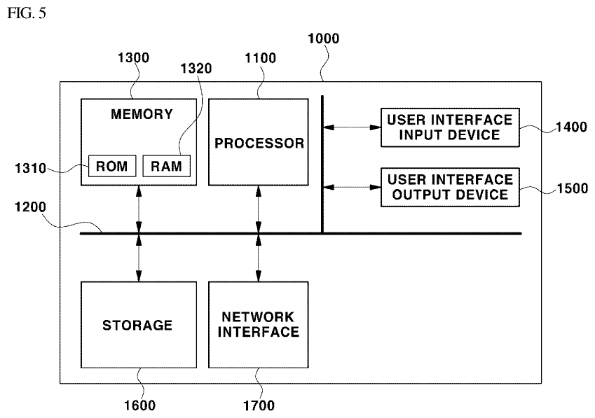

FIG. 5 shows an example computing system (e.g., a computing device of a vehicle or any other apparatus). One or more controllers, processors, etc. described herein, such as the electrode corrosion predictor 20, the controller 30, the mobile device 40, and any other components and devices disclosed herein, may be implemented by or in the computing system as shown in FIG. 5.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (PAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface (s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

In order to achieve at least one of the above objectives, the present disclosure provides a drive control system for a fuel cell vehicle, the system including: an electrode corrosion predictor configured to measure, upon startup of a vehicle equipped with a fuel cell stack, a concentration of carbon dioxide contained in exhaust gases emitted from the fuel cell stack; and a controller configured to diagnose a corrosion condition of an electrode of the fuel cell stack based on the concentration of carbon dioxide measured by the electrode corrosion predictor, and to selectively perform voltage conditioning control to maintain an output voltage of the fuel cell stack at a predetermined first voltage based on the diagnosis result.

The controller may be configured to calculate an increase in a carbon dioxide concentration of the exhaust gases upon startup of the vehicle, and determine whether to perform the voltage conditioning control based on the increase in carbon dioxide concentration.

The controller may be configured to determine a value calculated by subtracting a second carbon dioxide concentration value from a first carbon dioxide concentration value as the increase in the carbon dioxide concentration of the exhaust gas. In this case, the first carbon dioxide concentration value may be measured before the output voltage of the fuel cell stack reaches a predetermined second voltage during the vehicle startup, and the second carbon dioxide concentration value may be measured when the output voltage of the fuel cell stack reaches the second voltage during the vehicle startup.

The controller may be configured not to perform the voltage conditioning control if the increase in carbon dioxide concentration of the exhaust gases is less than or equal to a predetermined first increase. The controller may be configured to perform the voltage conditioning control based on a driver input signal if the increase in carbon dioxide concentration of the exhaust gases exceeds the first increase and is less than a predetermined second increase, wherein the second increase is greater than the first increase. Further, the controller may be configured to perform the voltage conditioning control if the increase in carbon dioxide concentration of the exhaust gases is greater than or equal to the second increase. The controller may be configured to perform the voltage conditioning control for a predetermined first period of time. Further, the driver input signal may be transmitted to the controller via a mobile terminal carried by the driver.

After performing the voltage conditioning control, the controller may be configured to limit the output current of the fuel cell stack for a predetermined second period of time such that the output voltage of the fuel cell stack is maintained at the first voltage or greater.

While limiting the output current of the fuel cell stack, the controller may be configured to maintain the opening of an air flow control valve (ACV) for controlling the amount of air supplied to the fuel cell stack at a predetermined value or greater.

According to another aspect of the present disclosure, there is provided a drive control method for a fuel cell vehicle, the method including: upon startup of a vehicle equipped with a fuel cell stack, measuring, by means of an electrode corrosion predictor, a concentration of carbon dioxide contained in exhaust gases emitted from the fuel cell stack; and by means of a controller, diagnosing a corrosion condition of an electrode of the fuel cell stack based on the concentration of carbon dioxide measured by the electrode corrosion predictor, and selectively performing voltage conditioning control to maintain an output voltage of the fuel cell stack at a predetermined first voltage based on the diagnosis result.

According to the above-mentioned construction, the present disclosure provides the following effects.

First, when excessive electrode corrosion of the fuel cell is predicted and determined upon vehicle startup, voltage conditioning control is performed to maintain the output voltage of the fuel cell stack at a predetermined voltage, thereby suppressing and minimizing excessive electrode corrosion of the fuel cell occurring during vehicle driving.

Second, it is possible to prevent the performance degradation of the fuel cell stack due to excessive electrode corrosion of the fuel cell.

Effects obtainable from the present disclosure are not limited to the aforementioned effects, and other effects not explicitly disclosed herein will be clearly understood by those skilled in the art from the description provided hereinafter.

Although one or more example embodiments of the disclosure have been described in detail herein, the terms or words used in the present specification and in the appended claims should not be interpreted as being limited merely to common and dictionary meanings. The scope of the disclosure is not limited to the foregoing example embodiments, and a person having ordinary skill in the art is able to make various modifications and improvements on the basis of the principle of the disclosure defined in the appended claims without departing from the scope of the disclosure as defined in the appended claims.

What is claimed is:

1. A drive control system comprising:
a gas detector configured to measure, after a startup of a vehicle equipped with a fuel cell stack, a concentration of carbon dioxide contained in an exhaust gas emitted from the fuel cell stack; and
a controller circuit configured to:
diagnose, based on the measured concentration of the carbon dioxide, a corrosion condition of an electrode of the fuel cell stack;
determine, based on the diagnosed corrosion condition, whether to perform voltage conditioning on the fuel cell stack to maintain an output voltage of the fuel cell stack at a predetermined first voltage; and
control, based on the output voltage of the fuel cell stack, an operation of the fuel cell stack.

2. The drive control system of claim 1, wherein the controller circuit is further configured to:
determine an amount of increase in the measured concentration of the carbon dioxide after the startup of the vehicle; and
determine, based on the amount of increase in the measured concentration of the carbon dioxide, whether to perform the voltage conditioning.

3. The drive control system of claim 2, wherein the controller circuit is configured to determine the amount of increase in the measured concentration of the carbon dioxide by:
determining a difference between a first carbon dioxide concentration value, measured at a first time during the startup of the vehicle, and a second carbon dioxide concentration value, measured at a second time during the startup of the vehicle, wherein the second time is later than the first time, and
wherein the output voltage of the fuel cell stack reaches a predetermined second voltage at the second time.

4. The drive control system of claim 2, wherein the controller circuit is configured to selectively perform the voltage conditioning by:
based on the amount of increase in the measured concentration of the carbon dioxide being less than or equal to a first threshold value, not performing the voltage conditioning.

5. The drive control system of claim 2, wherein the controller circuit is configured to selectively perform the voltage conditioning by:
based on an input signal from a driver of the vehicle and based on the amount of increase in the measured concentration of the carbon dioxide being greater than a first threshold value and less than a second threshold value, performing the voltage conditioning, wherein the second threshold value is greater than the first threshold value.

6. The drive control system of claim 5, wherein the controller circuit is configured to perform the voltage conditioning further based on the amount of increase in the measured concentration of the carbon dioxide being greater than or equal to the second threshold value.

7. The drive control system of claim 5, wherein the input signal is transmitted to the controller circuit via a mobile device associated with the driver.

8. The drive control system of claim 1, wherein the controller circuit is configured to perform the voltage conditioning for a predetermined period of time.

9. The drive control system of claim 1, wherein the controller circuit is further configured to, after performing the voltage conditioning, limit an output current of the fuel cell stack for a predetermined period of time such that the output voltage of the fuel cell stack is maintained at or above the predetermined first voltage.

10. The drive control system of claim 9, wherein the controller circuit is further configured to, while limiting the output current of the fuel cell stack, control an air flow control valve (ACV) to maintain an amount of air supplied to the fuel cell stack at or above a predetermined flow rate.

11. A method performed by an apparatus of a vehicle, the method comprising:
after a startup of the vehicle equipped with a fuel cell stack, measuring, by a controller circuit via a gas detector, a concentration of carbon dioxide contained in an exhaust gas emitted from the fuel cell stack;
diagnosing, by the controller circuit and based on the measured concentration of the carbon dioxide, a corrosion condition of an electrode of the fuel cell stack;
determining, based on the diagnosed corrosion condition, whether to perform voltage conditioning on the fuel cell stack to maintain an output voltage of the fuel cell stack at a predetermined first voltage; and
controlling, based on performing the voltage conditioning of the fuel cell stack, an operation of the fuel cell stack.

12. The method of claim 11, further comprising:
determining an amount of increase in the measured concentration of the carbon dioxide after the startup of the vehicle; and
determining, based on the amount of increase in the measured concentration of the carbon dioxide, whether to perform the voltage conditioning.

13. The method of claim 12, wherein the determining of the amount of increase in the measured concentration of the carbon dioxide comprises:
determining a difference between a first carbon dioxide concentration value, measured at a first time during the startup of the vehicle, and a second carbon dioxide concentration value, measured at a second time during the startup of the vehicle, wherein the second time is later than the first time, and
wherein the output voltage of the fuel cell stack reaches a predetermined second voltage at the second time.

14. The method of claim 12, further comprising:
not performing the voltage conditioning based on the amount of increase in the measured concentration of carbon dioxide being less than or equal to a first threshold value.

15. The method of claim 14, wherein the performing of the voltage conditioning comprises:
determining, based on an input signal from a driver of the vehicle and based on the amount of increase in the measured concentration of the carbon dioxide being greater than the first threshold value and less than a second threshold value, to perform the voltage conditioning, wherein the second threshold value is greater than the first threshold value.

16. The method of claim 15, wherein the input signal is transmitted to the controller circuit via a mobile device associated with the driver.

17. The method of claim 14, wherein the performing of the voltage conditioning comprises:
performing the voltage conditioning further based on the amount of increase in the measured concentration of the carbon dioxide being greater than or equal to the second threshold.

18. The method of claim 11, wherein the performing of the voltage conditioning comprises performing the voltage conditioning for a predetermined period of time.

19. The method of claim 11, further comprising, after the performing of the voltage conditioning, limiting an output current of the fuel cell stack for a predetermined period of time such that the output voltage of the fuel cell stack is maintained at or above the predetermined first voltage.

20. The method of claim 19, further comprising, while limiting the output current of the fuel cell stack, controlling an air flow control valve (ACV) to maintain an amount of air supplied to the fuel cell stack at or above a predetermined flow rate.
